(19) United States
(12) Patent Application Publication
(10) Pub. No.: US 2004/0029525 A1
(43) Pub. Date: Feb. 12, 2004

(54) Tuning engine and user interface for internet broadcasts on mobile devices

(75) Inventor: Harry Vertelney, Palo Alto, CA (US)

Correspondence Address: WEINGARTEN, SCHURGIN,, GAGNEBIN & LEBOVICI LLP, Ten Post Office Square, Boston, MA, 02109, US

(73) Assignee: SUN MICROSYSTEMS, INC.

(21) Appl. No.: 10/212,596

(22) Filed: Aug. 5, 2002

(51) Int. Cl. H04H 7/00

(52) U.S. Cl. 455/3.03; 455/3.06

(57) ABSTRACT

A system and method for accessing audio content over a global communications network such as the Internet or the Worldwide Web that can efficiently organize and categorize audio content of interest while providing a simple user interface to access the desired audio content. The system includes a Web radio device with a simplified user interface having a plurality of pushbuttons, a wireless transmission infrastructure, a gateway device, and a Web portal coupled to back-office devices that provide the processing of a tuning engine. The tuning engine finds and downloads Web pages associated with selected audio broadcasts, extracts information pertaining to the audio content of the Web broadcasts from the Web pages, and classifies the audio content into show classification types in the tuning engine based on a web page's key words or meta-data. User configured audio content is then categorized and assigned to the respective pushbuttons of the Web radio user interface to allow the user to access the audio content by activating a single one or a minimal number of the pushbuttons.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The present invention relates generally to systems and methods for accessing Internet audio data streams (audio “content”), and more specifically to systems and methods for accessing Internet audio content suitable for use in motor vehicles and standalone mobile devices.

In recent years, the streaming or “broadcasting” of audio content over data packet networks such as the Internet, e.g., the Worldwide Web (the “Web”), to users of Personal Computers (PCs) connected to the Internet has become commonplace. For example, Web broadcasts of audio content may be accessed by the PC user via a general-purpose browser application installed on the PC. Specifically, the PC user may invoke the browser application, and select a particular Web broadcast by using the PC keyboard to enter in a location field the Uniform Resource Locator (URL) of a Web site associated with the Web broadcast, and by pressing the Return key. Alternatively, the PC user may employ the browser application to access a Web site that includes a number of hyperlinks (“links”) to respective Web broadcasts, and use the PC keyboard or a mouse device connected to the PC to select a Web broadcast of interest. The Web site may provide a listing of the respective Web broadcast links in the form of a pull-down menu or a combo box identifying the possible Web broadcast selections. A Web broadcast link may also be selected from a “bookmark” or “favorite” list maintained by the PC user via the browser application.

More recently, computerized devices have been disclosed for accessing audio content over wireless connections to the Internet. For example, U.S. Pat. No. 6,314,094 (the “'094 patent”) to Boys describes a mobile wireless Internet portable radio (“Web radio”), which can be installed in a motor vehicle such as an automobile and operated by a user from within the vehicle to maintain a wireless connection to the Internet for accessing broadcasts of audio content. Specifically, the '094 patent describes a Web radio having a dedicated audio browser application installed on the device, and a user interface including a plurality of pushbuttons and a display adapted to list a limited number of Web broadcast links and to highlight a selected one of the listed links. The user of the Web radio can invoke the audio browser application, and select the highlighted link by activating one of the pushbuttons on the user interface. Further, the Web radio can be programmed to access a directory server upon connection to the Internet, and to download a list of links to Web broadcast servers from the directory server. Alternatively, the Web radio can be programmed through the user interface or via a serial port to access one or more Web broadcast links over the wireless Internet connection. Moreover, each pushbutton of the user interface can be associated with a specific Web broadcast link so that activation of a single pushbutton invokes the desired link. In this way, the Web radio can be made to mimic a conventional motor vehicle radio, which is typically designed for ease-of-use while minimizing undue distraction to the motor vehicle operator.

Although the computers and computerized devices described above may be employed to access audio content over land or wireless connections to the Internet, such devices have drawbacks in that they fail to provide a way of efficiently sorting out the myriad of Web audio broadcasts now available. For example, there are currently a great number of audio content providers from around the world that provide up to 24-hour broadcasting over the Internet. The areas of audio content provided by these Web broadcasters not only include music, news, weather, sports, and talk, but also college courses and other educational and informational content areas. Further, each of these audio content areas may include numerous sub-areas and/or one or more hierarchies of content areas. Accordingly, there is a need for an effective way of organizing and categorizing audio content provided by Web broadcasters to give users, particularly, users of mobile Web radio devices, easier and faster access to the desired audio content.

It would therefore be desirable to have a Web radio device that can be used to access broadcasts of audio content over the Internet. Such a Web radio would provide an effective way of organizing and categorizing Web broadcasts of interest to the user. It would also be desirable to have a Web radio that has a user interface that can be adapted to allow eye-busy/hands-busy access by the operator of a vehicle such as an automobile or a boat.

### BRIEF SUMMARY OF THE INVENTION

In accordance with the present invention, a system and method for accessing audio content over a global communications network such as the Internet, e.g., the Worldwide Web (the “Web”), is disclosed that can efficiently organize and categorize audio content of interest while providing a simple user interface to access the desired audio content. The presently disclosed system and method executes the organizing and categorizing of audio content areas in a tuning engine that employs a relational database. Further, the user interface allows a user to access the desired audio content within each audio content area by activating a minimal number of pushbuttons.

In one embodiment, the system for accessing audio content over the global communications network comprises a wireless application environment that includes a Web radio device with a simplified user interface having a plurality of pushbuttons, a wireless transmission infrastructure, a gateway device, and a Web portal coupled to back-office devices that provide the processing of a tuning engine. The Web radio comprises a mobile device suitable for installation in a motor vehicle such as an automobile, or a standalone mobile device. Further, the Web radio is configured to execute a browser application for establishing a wireless connection to the network via the wireless transmission infrastructure, and for selecting one of a plurality of Web audio broadcast links (“programs”) to access the desired audio content over the wireless network connection. Moreover, the back-office services provided by the tuning engine comprise a Web crawler, a program filter/classifier, a caching engine for accessing a cache memory, a user database engine for accessing a user database, and a program database engine for accessing a program database. The user database includes a user identifier table (“user table”) and a user preference table (“preferences table”), and the program database includes an audio content table (“content table”) and a Web broadcast stations table (“Web stations table”). The back-office services further comprise a user and program information validating engine, and a program availability-testing engine.

In the presently disclosed embodiment, a user device such as a general-purpose computer executing a browser-based configuration application is employed for determining the user preferences and the program choices. Specifically, the user device establishes a connection to the communications network, and executes the configuration application to allow the user to enter (1) the user identifier information in the user table, (2) the description of the user preferences in the preferences table, (3) the program choices and program order information in the content table, and (4) the program scheduling information in the Web stations table. The Web crawler is operative to find and download Web pages associated with the chosen programs from one or more broadcast servers connected to the Internet. Further, the program filter/classifier is operative to extract program information (e.g., keywords and/or other identifying attributes pertaining to the audio content characteristics of the programs) from the downloaded Web pages, and to filter/classify the program information based on the Web pages' keywords or meta-data, which is then entered into the tuning engine database. The classified program content can then be ordered by the user via the configuration application to create collections of play lists (“shows”). Moreover, the shows can be categorized and assigned to the respective pushbuttons of the Web radio user interface to allow the user to access the audio content contained in the shows by activating a single one or a minimal number of the pushbuttons.

By providing a Web radio device in which disparate Web audio broadcasts can be ordered by user criteria in at least one play list so that when a user activates a pushbutton on a user interface of the device, the Web radio invokes the appropriate program(s) on the list, easier and faster access to a hierarchy of stored audio content can be achieved.

Other features, functions, and aspects of the invention will be evident from the Detailed Description of the Invention that follows.

### BRIEF DESCRIPTION OF THE SEVERAL VIEWS OF THE DRAWING

The invention will be more fully understood with reference to the following Detailed Description of the Invention in conjunction with the drawings of which:

FIG. 1 is a block diagram of a system architecture for accessing audio content over a data packet network via a Web radio device, the system architecture including a functional architecture of a tuning engine according to the present invention;

FIG. 2a is a block diagram of the Web radio device employed in the system architecture of FIG. 1;

FIG. 2b depicts a user interface included in the Web radio device of FIG. 2a; and

FIGS. 3a-3e are flow diagrams illustrating the processing of the tuning engine of FIG. 1.

### DETAILED DESCRIPTION OF THE INVENTION

A system and method for accessing audio content over a data packet network is disclosed that efficiently sorts out audio broadcasts of interest from disparate audio broadcasts, and provides a simple user interface to access the desired audio content.

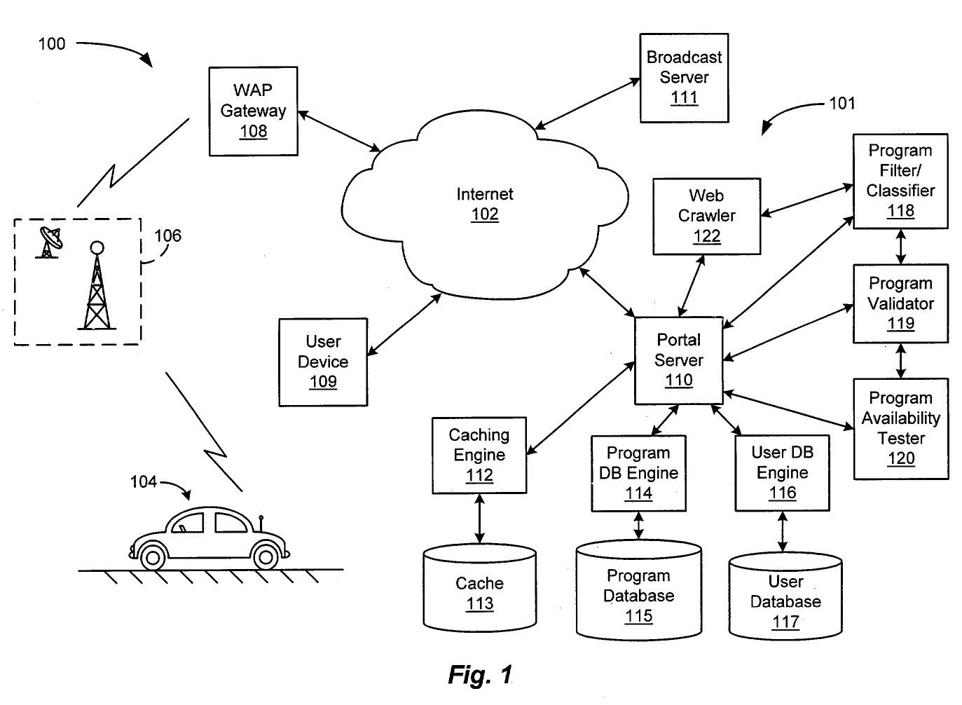

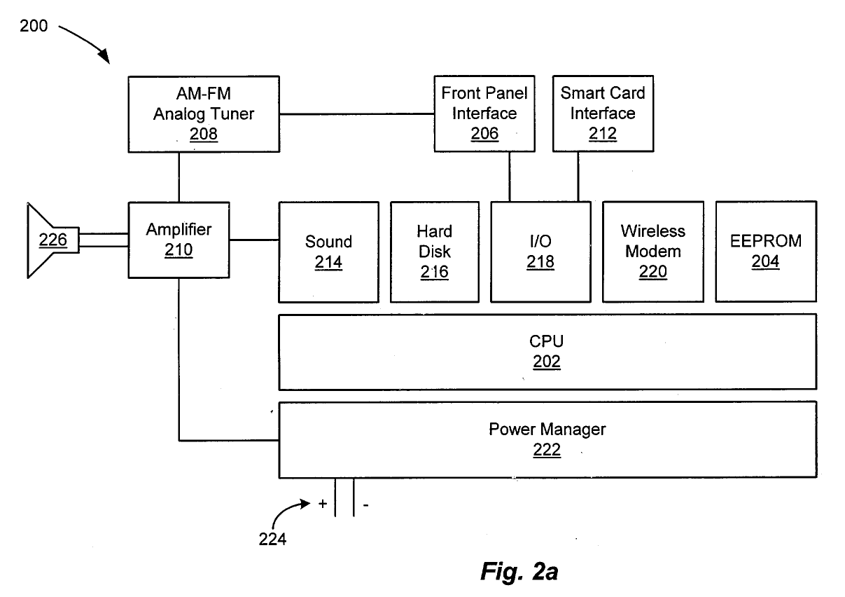

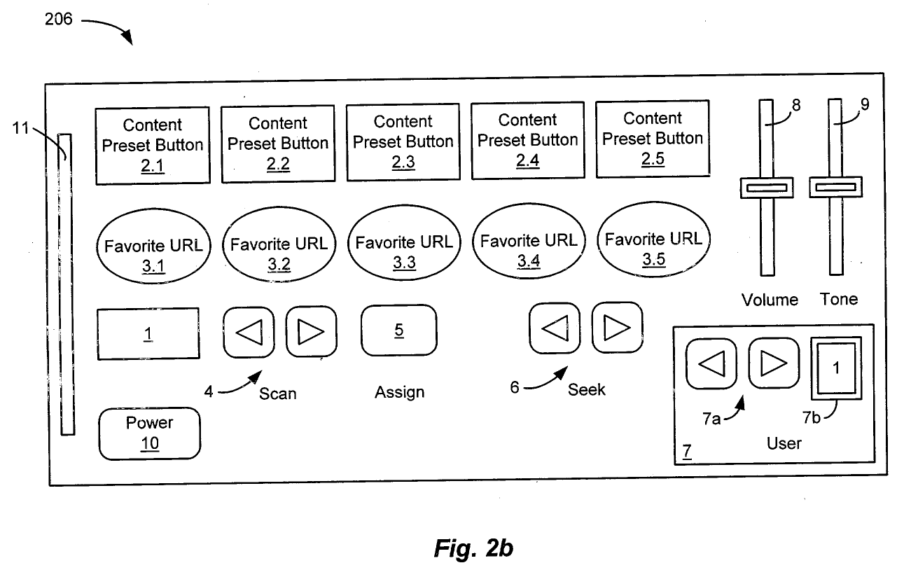

FIG. 1 depicts an illustrative embodiment of a system 100 for accessing audio content over a global communications network such as the Internet 102, e.g., the Worldwide Web (the “Web”), in accordance with the present invention. In the illustrated embodiment, the system 100 comprises a wireless application environment, as defined by the Wireless Application Protocol (WAP) specification 1.1, which is incorporated herein by reference. The WAP specification 1.1 defines a set of communication protocols that enable wireless devices to connect to the Internet 102, and to access services provided over the Internet 102. Specifically, the system 100 includes a Web radio device 200 (see FIG. 2a) installable in a vehicle 104 (see FIG. 1) such as an automobile or a boat, a wireless transmission infrastructure 106, a WAP gateway device 108, a user device 109, an audio broadcast server 111, and a Web portal server 110 coupled to back-office devices that provide the processing of a tuning engine 101 for the Web radio.

It should be understood that the wireless application environment mentioned above may conform to any suitable set of communication protocols for connecting wireless devices, e.g., the Web radio 200 (see FIG. 2a), to the Internet 102 (see FIG. 1). The system 100 is described herein with reference to the communication protocols of the WAP specification 1.1 for purposes of illustration. Further, the Web radio 200 may comprise a standalone mobile device such as a standalone Web radio, or alternatively a wireless phone, pager, or Personal Digital Assistant (PDAs) configured to allow a user to access audio content hosted on at least one broadcast server, e.g., the broadcast server 111, over the Internet 102. Moreover, the user device 109 may comprise a general-purpose computer such as a Personal Computer (PC) or a computerized device such as a PDA connectable to the Internet 102 via a land or wireless connection.

In the presently disclosed embodiment, the Web radio 200 (see FIG. 2a) is configured to transmit and receive data streams (“content”) written in the Wireless Markup Language (WML), which is employed to produce content conforming to the Wireless Application Protocol (WAP). It is understood, however, that other suitable wireless messaging technologies may be used instead of WML such as the compact HyperText Markup Language (cHTML) or the Handheld Device Markup Language (HDML).

FIG. 2a depicts an illustrative embodiment of the Web radio 200, which comprises a hybrid analog radio/Web-based digital radio capable of selectively accessing AM/FM radio broadcasts via a conventional AM/FM analog tuner 208, or Web broadcasts of audio content. It is understood, however, that the Web radio 200 may alternatively comprise a dedicated Web-based digital radio device. Specifically, the Web radio 200 includes a Central Processing Unit (CPU) 202, non-volatile memory 204 such as Electrically Erasable Programmable Read Only Memory (EEPROM), and a front panel user interface 206, which in combination are configured to support a browser application. For example, the browser application may comprise a micro-browser adapted for establishing a wireless connection to the Internet 102 (see FIG. 1), and for selecting one or more hyperlinks (“links”) to access desired audio content over the wireless Internet connection. The EEPROM 204 is configured to store applications software such as an audio player application, and systems software such as operating system software, wireless modem software, and communication protocol software, which in the presently disclosed embodiment conforms to the WAP specification 1.1. As described above, the Web radio is installable in the vehicle 104 (see FIG. 1). Accordingly, the Web radio 200 (see FIG. 2a) is configured to be powered by a battery 224 coupled to a power manager 222, which conditions the power supplied by the battery 224 and converts it to levels suitable for use by the analog and digital circuitry of the Web radio 200.

The Web radio 200 further includes wireless modem circuitry 220 and an Input/Output (I/O) data port 218, which are configured to allow the Web radio to transmit and receive in a wireless communication mode. Moreover, the Web radio 200 includes a hard disk 216 providing non-volatile storage of user information and information pertaining to audio broadcasts of interest to the user, and a sound card 214 enabling the audio broadcasts to be heard by the user via at least one speaker 226. It is noted that the AM/FM analog tuner 208 and the sound card 214 are coupled to a power amplifier 210 for driving the speaker 226. The functionality of the Web radio 200 is controlled via the front panel user interface 206 and a smart card interface 212, as described below.

As shown in FIG. 1, the wireless connection from the Web radio in the vehicle 104 to the Internet 102 is established via the wireless transmission infrastructure 106 and the WAP gateway 108. Specifically, the transmission infrastructure 106 includes one or more antennas (not numbered) and/or satellite stations (not numbered) configured for providing two-way wireless communication between the Web radio and the WAP gateway 108. For example, the transmission infrastructure 106 may conform to the Global System for Mobile communication (GSM), Time Division Multiple Access (TDMA), or Code Division Multiple Access (CDMA) network technology, or any other suitable wireless broadband network technology. Further, the WAP gateway 108 comprises a computer, e.g., a server, configured to convert and route WML commands from the Web radio to the Web portal 110 for accessing the back-office services of the tuning engine 101, and to the broadcast server 111 for accessing the desired audio content over the Internet 102. Specifically, the WAP gateway 108 receives the WML commands from the Web radio, converts the WML commands to corresponding Hyper Text Transfer Protocol (HTTP) requests, and transmits the HTTP requests to the Web portal 110 and/or the broadcast server 111. It is noted that the user device 109 is also configured to transmit HTTP requests to the Web portal server 110. The Web portal 110 is configured to receive the HTTP requests from the Web radio and the user device 109, to interpret the HTTP requests, and to communicate with the back-office devices to satisfy the HTTP requests.

In the preferred embodiment, the Web portal 110 comprises an iplanet™ Portal Server and a Mobile Access Pack, which are commercially available from Sun Microsystems™, Inc. The Mobile Access Pack enables wireless access to the iPlanetT™ Portal Server, which is a component of the Sun™ Open Net Environment (“Sun ONE”). Further, the Mobile Access Pack extends the services provided via the iPlanet™ Portal Server to mobile devices such as the Web radio 200 (see FIG. 2a). The iPlanet™ Portal Server and the Mobile Access Pack are described in the iPlanet™ Portal Server Mobile Access Pack 3.0, Wireless Access to Portal Content & Services, A Technical White Paper, copyright 2001 Sun Microsystems™, Inc., which is incorporated herein by reference.

In the presently disclosed embodiment, the system 100 (see FIG. 1) sorts out audio broadcasts of interest to the Web radio user by organizing and categorizing audio content areas via the tuning engine 101, which employs a relational database. Specifically, the tuning engine 101 comprises a Web crawler 122, a program filter/classifier 118, a program validator 119, a program availability tester 120, a caching engine 112 for accessing a program cache 113, a program database engine 114 for accessing a program database 115, and a user database engine 116 for accessing a user database 117. The Web crawler 122 is operative to locate and download Web pages associated with respective Web audio broadcast links (“programs”) from one or more broadcast servers, e.g., the broadcast server 111, connected to the Internet 102. Further, the program filter/classifier 118 is operative to extract program information, e.g., keywords and/or other identifying attributes pertaining to the audio content characteristics of the programs, from the downloaded Web pages, and to filter/classify the program information into a number of audio content areas (e.g., music, news, weather, sports, talk, education, etc.) based on the Web pages' keywords or meta-data, which is then entered into the database of the tuning engine 101.

For example, the program filter/classifier 118 may read the Web page, and extract a program schedule from the downloaded document. The program filter/classifier 118 may then parse the program schedule, and perform a search for a number of keywords and/or phrases in the program schedule. Next, the program filter/classifier 118 may compare the located keywords/phrases with corresponding user criteria stored in the database of the tuning engine 101, and then assign the program associated with the Web page to a particular audio content area (e.g., music, news, weather, sports, talk, education, etc.) or sub-area (e.g., classical music, pop music, oldies music, etc.) based on the results of the comparison. It is noted that the program filter/classifier 118 may extract meta-data and/or meta-tags from the Web page, keywords from the Uniform Resource Locator (URL) associated with the Web page, or any other suitable information identifying the content of the downloaded document.

Moreover, the program validator 119 is operative to authenticate the source of the user and program information, and to post the authenticated information in the relational database of the tuning engine 101. The program availability tester 120 operates as a daemon process to continuously determine whether the programs are reachable, and to test the general Quality of Service (QoS) characteristics of the programs. The caching engine 112 is operative for temporarily storing information pertaining to the programs, i.e., URLs associated with the programs, in the cache memory 113. It should be appreciated that the relational database of the tuning engine 101 comprises the user database 117 including a user identifier table (“user table”) and a user preference table (“preferences table”), and the program database 115 including an audio content table (“content table”) and a Web broadcast station table (“Web stations table”).

In the illustrated embodiment, the user device 109 executing a browser-based configuration application is employed to determine the user preferences such as the programs of interest to the user. Specifically, the user device 109 is configured to execute a general-purpose browser application such as the NETSCAPE NAVIGATOR™ browser or the MICROSOFT INTERNET EXPLORER™ browser to establish a connection to the Internet 102, and to enter criteria such as (1) the user identifier information in the user table, (2) the program selections and program order information in the content table, (3) the description of the user preferences in the preferences table, and (4) the program scheduling information, in the Web stations table. For example, a user ID may be employed to associate the user with a particular set of user preferences stored in the preferences table including preferred types of programs or play lists (“shows”). In an alternative embodiment, the Web radio 200 may be configured to execute the user configuration application, thereby obviating the need for the user device 109. TABLES 1-4 below depict an illustrative table schema for the relational database of the tuning engine 101 (see FIG. 1).

TABLE 1
USER TABLE

| | Data | |
|---|---|---|
| Field | Type | Description |
| User_id | Int | A numerical ID |
| | | associated with a |
| | | particular user. |
| User_name | String | An alphanumeric name |
| | | associated with the |
| | | user. |
| User_password | String | An alphanumeric password |
| | | associated with the |
| | | user. |
| User_smart_card_id | String | An alphanumeric password |
| | | containing the user ID |
| | | and configuration info. |
| User_num_alias | Int | A numerical ID alias for |
| | | switching between users |
| | | of the same Web radio. |
| User_primary_radio_id | String | An alphanumeric ID |
| | | associated with the Web |
| | | radio. |

TABLE 2
CONTENT TABLE

| | Data | |
|---|---|---|
| Field | Type | Description |
| User_id | Int | A numerical ID for |
| | | associating a particular |
| | | user with a program. |
| Type | Web_stations. | A single show type. |
| | show_classification | |
| URL | Web_stations. | A single URL. |
| | station_url | |
| Favorites | Boolean | Indicates inclusion on a |
| | | favorites list. |
| Favorites_order | Int | Program order info |
| | | associated with the |
| | | favorites list. |
| Favorite_button_{—} | Int | Indicates assignment of |
| assignment | | favorite button on user |
| | | interface. |
| Shows | Boolean | Indicates inclusion on a |
| | | show list. |
| Show_order | Int | Program order info |
| | | associated with the show |
| | | list. |
| Show_button_{—} | Int | Indicates assignment of |
| assignment | | show button on user |
| | | interface. |

TABLE 3
PREFERENCES TABLE

| | Data | |
|---|---|---|
| Field | Type | Description |
| User_id | Int | A numerical ID |
| | | associating a particular |
| | | user with a preference |
| | | set. |
| Scan_duration | Int | Number of seconds a user |
| | | can listen to a scanned |
| | | station before the Web |
| | | radio goes to the next |
| | | URL on the play list. |
| Preferred_type1 | String | Specifies a 1^{st} preferred |
| | | type of program or show. |
| Preferred_type2 | String | Specifies a 2^{nd} preferred |
| | | type of program or show. |
| Preferred_type3 | String | Specifies a 3^{rd} preferred |
| | | type of program or show. |
| Preferred_type4 | String | Specifies a 4^{th} preferred |
| | | type of program or show. |
| Preferred_type5 | String | Specifies a 5^{th} preferred |
| | | type of program or show. |
| Time_start | Time | A start time associated |
| | | with a user. |
| Time_end | Time | An end time associated |
| | | with a user. |
| Monday | Boolean | Enables a specific |
| | | configuration for Mon. |
| Tuesday | Boolean | Enables a specific |
| | | configuration for Tues. |
| Wednesday | Boolean | Enables a specific |
| | | configuration for Wed. |
| Thursday | Boolean | Enables a specific |
| | | configuration for Thurs. |
| Friday | Boolean | Enables a specific |
| | | configuration for Fri. |
| Saturday | Boolean | Enables a specific |
| | | configuration for Sat. |
| Sunday | Boolean | Enables a specific |
| | | configuration for Sun. |
| Maxurl_per_type. | Int | Specifies the maximum |
| content_type | | number of URLs to scan |
| | | for a particular content |
| | | type. |
| Buffer_size | Int | Specifies the cache |
| | | buffer size. |
| Interstitial | String | Latency masking sound |
| | | file. |
| Interstitial_{—} | Int | On-board storage buffer |
| buffer_size | | size for interstitial |
| | | file. |

TABLE 4
WEB STATIONS TABLE

| | Data | |
|---|---|---|
| Field | Type | Description |
| Station_url | String | Specifies the Web |
| | | station URL. |
| Station_schedule_{—} | String | Specifies the Web |
| url | | station schedule URL. |
| Station_IP | String | Format: xxx.xxx.xxx.xxx |
| Station_nickname | String | May specify call letters |
| | | or a slogan. |
| Is_available | Boolean | Specifies entry of the |
| | | availability daemon. |
| Num_station_{—} | Int | Specifies number of |
| connections | | times web station is |
| | | examined by Web crawler. |
| Connection_times | Int list | In Seconds, e.g., 22 41 |
| | | 17. |
| Average_{—} | Float | Connection_times/num_{—} |
| connection_time | | station_connections |
| Show_name | String | Specifies a show's name. |
| Announcer_name | String | Specifies the announcer |
| | | or group name. |
| Show_{—} | String | For example, news.local, |
| classification | | weather, |
| | | sports.games.football. |
| Show_start | Time | Specifies the show start |
| | | time. |
| Show_end | Time | Specifies the show end |
| | | time. |
| Station_keywords | String | Includes the keywords |
| | | extracted by the program |
| | | filter/classifier. |
| Popularity_{—} | Int | Specifies the number of |
| number | | listeners who have this |
| | | station on their list. |
| Popularity_{—} | Int | Specifies the number of |
| duration | | listened minutes/day * |
| | | Popularity number. |
| Popularity_start_{—} | Time | Specifies the listener's |
| time | | start time. |
| Popularity_accumulated_{—} | Time | Specifies accumulated |
| mins | | listened minutes/day. |

As described above, the program filter/classifier 118 is operative to filter/classify program information, e.g., the program information entered in the contest table (seeTable 2) and the Web stations table (see Table 4) of the relational database, into a number of audio content areas. The user may further employ the user configuration application to order and categorize the classified program content to create collections of shows, and to assign the shows to respective buttons of the Web radio user. interface 206 (see FIG. 2a), for subsequently allowing the user to access the audio content contained in the shows by activating a single one or a minimal number of the buttons. It is noted that each show comprises a list of programs, each program corresponding to a respective Web audio broadcast and having an associated global network address (e.g., a URL).

FIG. 2b depicts an illustrative embodiment of the Web radio user interface 206 (see FIG. 2a). In the illustrated embodiment, the user interface 206 includes a plurality of audio content area preset buttons 2.1-2.5, a plurality of favorite URL buttons 3.13.5, a display 1 for indicating a number corresponding to the currently activated button, scan buttons 4 for successively accessing the previous/next URL in the show associated with the selected content preset button 2.1-2.5, seek buttons 6 for accessing the previous/next URL in the show, an assign button 5 for assigning a particular URL in the show to one of the favorite URL buttons 3.1-3.5, a user ID input 7 including user ID scan buttons 7a and a user ID display 7b for entering the user's ID, a volume controller 8, a tone controller 9, and a power on/off switch 10. It is noted that the user may enter his/her user ID to cause the Web radio to access the user's preference set in the relational database (see the User_id field of the preferences table—TABLE 3). Accordingly, upon user activation of one of the audio content area preset buttons 2.1-2.5, the favorite URL buttons 3.1-3.5, the scan buttons 4, or the seek buttons 6, the Web radio invokes the browser application to establish a wireless connection to the Internet, and to enter a single URL (e.g., a favorite URL) or successive URLs (e.g., a show corresponding to one of the preset content areas), thereby accessing the desired audio content over the wireless Internet connection.

As described above, the user may employ the user device 109 (see FIG. 1) and the user configuration application to enter the user identifier information, to assign shows to the respective content preset buttons 2.1-2.5, and to assign favorite programs to the respective favorite URL buttons 3.1-3.5 (see FIG. 2b). In the preferred embodiment, a smart card 11 (see FIG. 2b) is employed for storing the user and program information entered by the user via the configuration application, and for transferring the user/program information to the hard disk 216 of the Web radio 200 (see FIG. 2a). For example, the user device 109 may comprise a smart card reader (not shown) configured to receive the smart card 11. The user may employ the user device 109 to access the user and program information entered in the relational database of the tuning engine 101 (see FIG. 1), and provide the user/program information to non-volatile memory included in the smart card 11 (see FIG. 2b). Next, the user may remove the smart card 11 from the smart card reader, and couple the smart card 11 to the smart card interface 212 (see FIG. 2a) to transfer the user/program information from the smart card memory to the hard disk 216 (see FIG. 2a). It is understood that the Web radio 200 (see FIG. 2a) includes controls (not shown) for allowing the user to initiate the transfer of the user and program information from the smart card memory to the Web radio storage via the smart card interface 212. The processing circuitry of the Web radio 200 then accesses the user and program information on the hard disk 216, and makes the appropriate button assignments based on the preference set of the user.

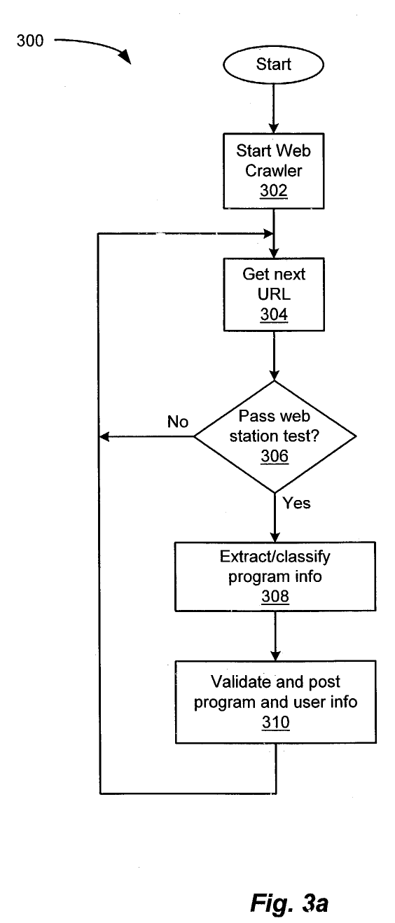

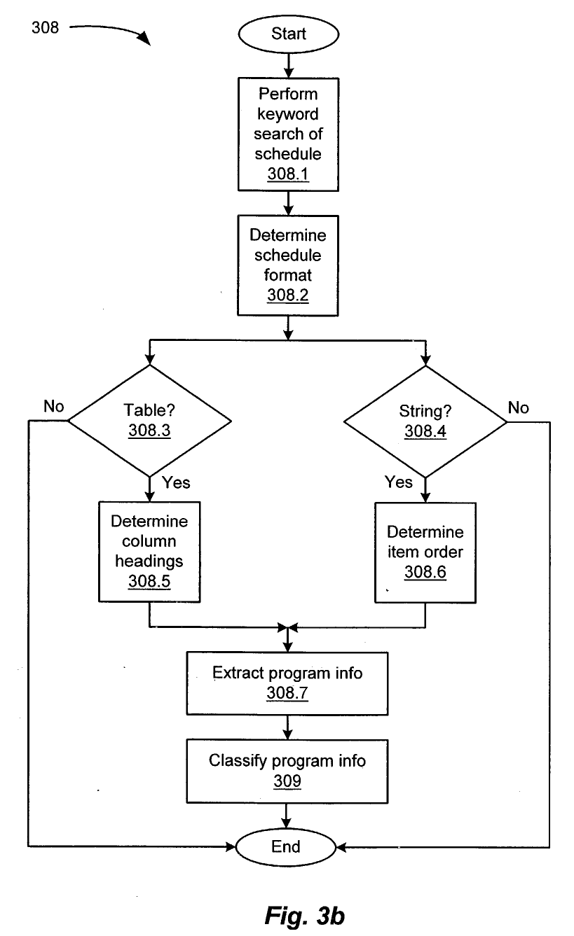

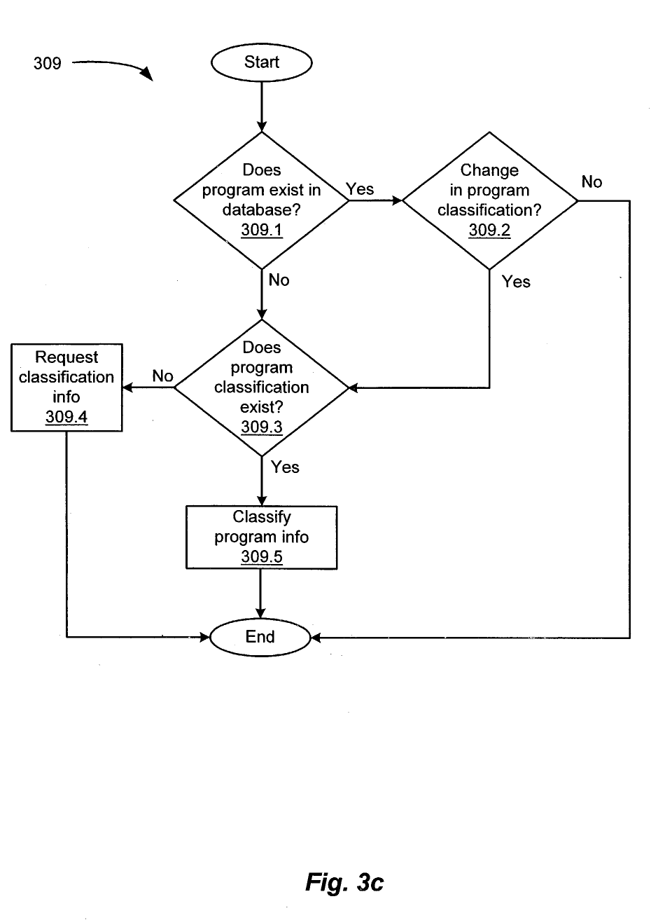

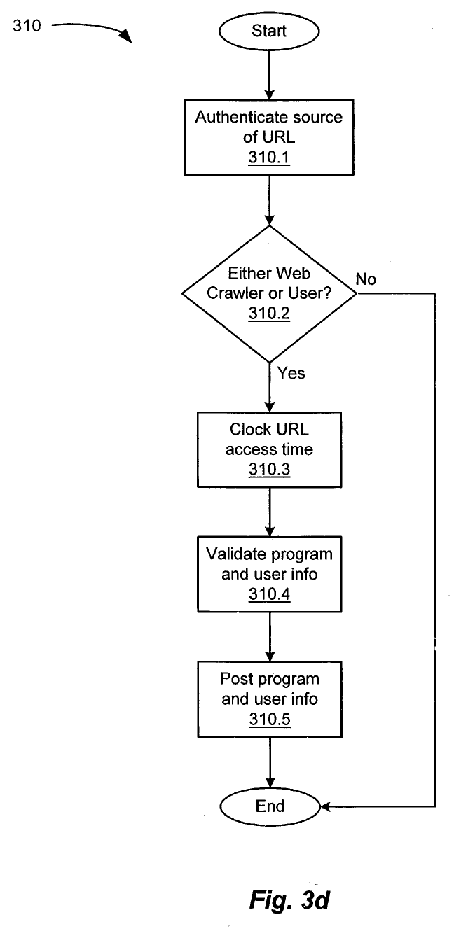

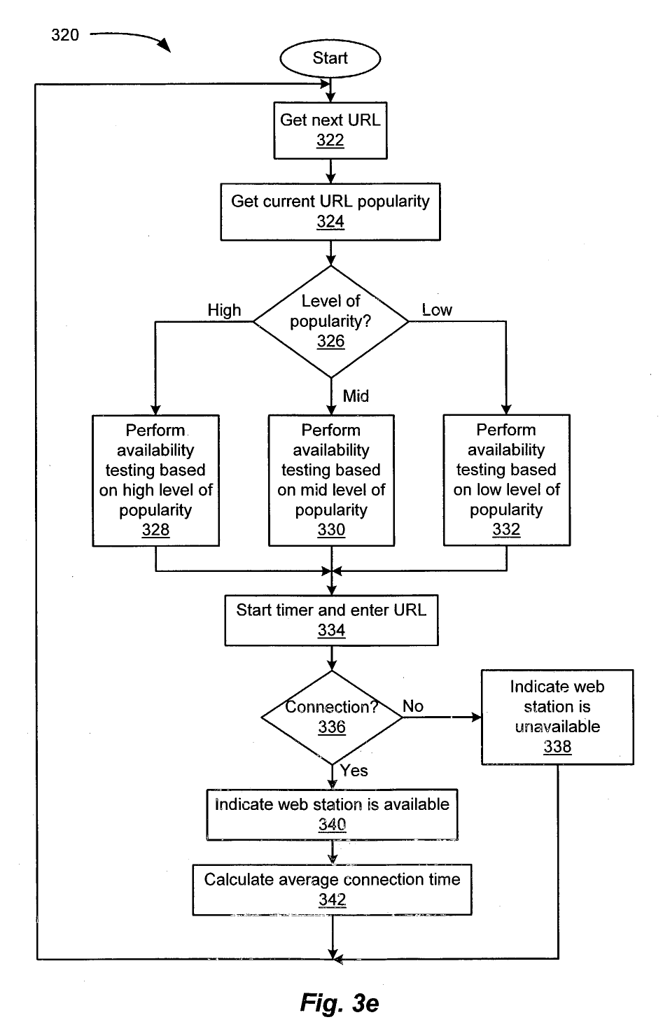

A method of extracting, classifying, validating, and posting user identifier information, and program information associated with one or more Web audio broadcasts, using the processing logic of the tuning engine 101 (see FIG. 1), is illustrated by reference to FIGS. 3a-3d. As depicted in step 302 (see FIG. 3a), upon transmission of a suitable user command via the configuration application, the Web crawler is started. Next, the Web crawler gets, as depicted in step 304, a Web site URL associated with a predetermined Web audio broadcast, and attempts to download a Web page at that address location. For example, the Web site URL may be initially stored in the Station_url field of the Web stations table (see TABLE 4). Alternatively, the URL may comprise the Web station schedule URL, and be initially stored in the Station_schedule_url field of the Web stations table (see TABLE 4). A determination is then made, as depicted in step 306, as to whether the URL passed the Web station test, i.e., whether the Web crawler successfully accessed the Web site and subsequently downloaded a document such as the Web station schedule. In the event the Web site cannot be contacted, the Web crawler loops back to step 304 to get the next Web station URL from the Web stations table. In the event the Web site is successfully contacted, the program filter/classifier extracts and classifies, as depicted in step 308, the program information included in the Web station schedule. The steps included within step 308 of FIG. 3a are depicted in greater detail in FIG. 3b.

As depicted in step 308.1 (see FIG. 3b), the program filter/classifier performs a search for one or more predetermined keywords in the Web station schedule. Next, the program filter/classifier determines, as depicted in step 308.2, the format of the Web station schedule. In the event the Web station schedule is formatted as a table (see step 308.3), the program filter/classifier makes a determination, as depicted in step 308.5, of the column headings in the table. In the event the Web station schedule is formatted as a string (see step 308), the program filter/classifier makes a determination, as depicted in step 308.6, of the item (e.g., keyword) order in the string. In the event the Web station schedule format is neither a table nor a string, the schedule is in an unknown format and the procedure terminates. The program filter/classifier then extracts, as depicted in step 308.7, the program information from the Web station schedule based on the results of the keyword search and the schedule format determination. Next, the program filter/classifier classifies, as depicted in step 309, the program information. The steps included within step 309 of FIG. 3b are depicted in greater detail in FIG. 3c.

As depicted in step 309.1 (see FIG. 3c), a determination is made by the program filter/classifier as to whether program classification information currently exists in the program and user databases for the Web station schedule. In the event the classification information currently exists in at least one of the databases, the program filter/classifier determines, as depicted in step 309.2, whether the program classification has changed. In the event there is no change in the program classification, the procedure terminates. In the event the program classification has changed, the program filter/classifier determines, as depicted in step 309.3, whether the new classification for this program exists in the database. In the event the new program classification does not exist in the database, the Web crawler issues a request, as depicted in step 309.4, to the Web site for information pertaining to the new program classification, and the procedure terminates. In the event the new program classification exists in the database, the program filter/classifier classifies, as depicted in step 309.5, the program information. For example, the program filter/classifier may assign the program to a particular audio content area (e.g., music, news, weather, sports, talk, education, etc.) based on the corresponding program classification information. Next, the program validator validates and posts, as depicted in step 310 (see FIG. 3a), the user and/or program information in the user and program databases. The steps included within step 310 of FIG. 3a are depicted in greater detail in FIG. 3d.

As depicted in step 310.1 (see FIG. 3d), the program validator authenticates the source of the Web site URL.

Specifically, the program validator makes a determination, as depicted in step 310.2, as to whether the Web site URL was acquired via the user, or via the Web crawler. For example, the user may have entered the Web site URL in the relational database of the tuning engine via the user configuration application. Alternatively, the Web crawler may have extracted the Web site URL from the downloaded Web station schedule. In the event neither the Web crawler nor the user is the source of the Web site URL, the source is unknown and the procedure terminates. In the event either the Web crawler or the user is the source of the Web site URL, the program validator clocks, as depicted in step 310.3, the time at which the Web crawler accessed the corresponding Web site. Next, the program validator validates, as depicted in step 310.4, the user and/or program information. For example, the program validator may insert an indication in the user and/or program information that the information is from a valid source. The program validator then employs the user database engine and/or the program database engine to post, as depicted in step 310.5, the validated information in the appropriate user and/or program database. Finally, the procedure loops back to step 304 to allow the Web crawler to get the next Web site URL. For example, the Web crawler may extract another Web site URL from the Web station schedule.

As described above, the program availability tester 120 (see FIG. 1) continuously determines whether the programs of interest to the user are reachable, and tests the general Quality of Service (QoS) characteristics of the programs. A method of testing the availability of a particular program using the logic of the program availability tester 120 is illustrated by reference to FIG. 3e. As depicted in step 322, the Web crawler gets a Web site URL associated with a predetermined Web audio broadcast. Next, the program availability tester gets, as depicted in step 324, the current popularity of the Web audio broadcast. Specifically, the program availability tester determines, as depicted in step 326, the current level of popularity of the Web audio broadcast by accessing the value in the Popularity_number field of the Web stations table (see TABLE 4), which specifies the number of listeners who have this Web station on their favorites list. Next, the program availability tester performs availability testing on the Web site URL, as depicted in steps 328, 330, and 332, based on whether the popularity level is high, mid-level, or low. For example, the program availability tester may initiate an echo-request routine for the Web site at a frequency based on the level of popularity. Alternatively, the program availability tester may perform availability testing on the Web sites on a round-robin basis. The program availability tester then starts a timer (not shown) and enters the Web site URL, as depicted in step 334, in an attempt to contact the Web site. Next, the program availability tester determines, as depicted in step 336, whether a connection has been successfully made with the Web site. In the event the Web site cannot be contacted within a predetermined time interval, the program availability tester indicates, as depicted in step 338, that the Web station is unavailable. For example, the program availability tester may insert an indication of the Web station's unavailability in the program database. In the event the connection is successfully made with the Web site, the program availability tester indicates, as depicted in step 340, that the Web station is available. For example, the program availability tester may cause the value in the Connection_times field of the Web stations table (see TABLE 4) for that program to be incremented. The program availability tester then calculates, as depicted in step 342, the average connection time for the Web site, and stores the calculated value in the Average_connection_time field of the Web stations table (see TABLE 4).

The user's interaction with the presently disclosed system 100 (see FIG. 1) will be better understood with reference to the following illustrative examples. In these examples, it is understood that the user configuration application installed on the user device 109 performs processing tasks in response to one or more commands input by the user via a keyboard or mouse coupled to the device 109. In the first example, the user wishes to set various listening preferences on the Web radio. Accordingly, the user inputs suitable commands via the configuration application for entering (1) a selected user name in the User_name field, (2) a selected user password in the User_password field, and (3) an ID number associated with the Web radio in the User_primary_radio_id field, of the user table (see TABLE 1). Moreover, the user enters (1) a preferred type of program (e.g., music, news, weather, sports, talk, or education) in the Preferred_type1 field, and (2) the scan time duration in the Scan_duration field, of the preferences table (see TABLE 3).

In the second example, the user wishes to have a varied listening experience each time he/she activates a selected one of the audio content preset buttons 2.1-2.5. Accordingly, the user inputs suitable commands via the configuration application to (1) identify a particular show by a name (e.g., “hear-it-all”) employing the Show_name field of the Web stations table (see TABLE 4), and (2) select all program classifications currently existing in the tuning engine database employing the Show_classification field of the Web stations table (see TABLE 4). Next, the user inputs suitable commands to (3) perform a random selection of programs in the different audio content areas for creating the show employing the Shows field of the content table (see TABLE 2), and (4) assign the show to the selected content preset button 2.1-2.5 employing the Show_button_assignment field of the content table (see TABLE 2).

In the third illustrative example, the user wishes to set up a Monday through Friday commute time show that strings together the following programs—the traffic report on the Bay Bridge at 8:05 AM, the daily weather report, news headlines, baseball scores, stock quotes, and the freeway traffic report. Accordingly, the user inputs suitable commands via the configuration application to (1) identify the show by a name, e.g., “daily commute”, employing the Show_name field of the Web stations table (see TABLE 4), (2) view the program classifications for his/her location (e.g., San Francisco) and the sub-areas associated with that location (e.g., traffic reports, bridge traffic reports), (3) select the desired program (e.g., the “every 5-minute morning Bay Bridge report”), (4) select the desired day(s) of the week for listening to the program, e.g., Monday through Friday, employing the Monday through Sunday fields of the preferences table (see TABLE 3), and (5) select the program start time, e.g., 8:05 AM, employing the Show_start and Show_end fields of the Web stations table (see TABLE 4). Next, the user repeats these commands for each of the programs in the play list, as described above. The user then assigns the show to a selected content preset button 2.1-2.5.

In the fourth illustrative example, the user wishes to set individual URLs in a predetermined scan/seek order. For example, the user may desire a succession of blues, jazz, and rock-n-roll programs. Accordingly, the user inputs suitable commands via the configuration application to (1) identify the show by a name, e.g., “blues/jazz/rock-n-roll”, employing the Show name field, (2) view the music program classification in the tuning engine database and select the desired sub-areas (e.g., blues, jazz, rock-n-roll), (3) set the desired number of programs in each subarea, e.g., 10, employing the Maxurl_per_type.content_type field of the preferences table (see TABLE 3), (4) view the URL list for each sub-area, and (5) set the predetermined scan/seek order within each sub-area employing the Show_order field of the content table (see TABLE 2). Next, the user assigns the show to a selected content preset button 2.1-2.5. After transferring the program information to the Web radio, the user activates the selected content preset button 2.1-2.5, and the scan or seek button 4 and 6, to listen to the “biues/jazz/rock-n-roll” show in the predetermined scan/seek order.

It will further be appreciated by those of ordinary skill in the art that modifications to and variations of the above-described tuning engine and user interface for Internet broadcasts on mobile devices may be made without departing from the inventive concepts disclosed herein. Accordingly, the invention should not be viewed as limited except as by the scope and spirit of the appended claims.

What is claimed is:

1. A system for accessing audio content over a global communications network, comprising:
a radio communicably connectable to the network, the radio including a user interface having a plurality of tuning control inputs; and
a tuning engine for the radio, the tuning engine being operative to store user preference information for at least one radio user including at least one preferred audio content type, to receive audio content information including at least one network address associated with a respective audio content type, and to classify the audio content information based on at least one attribute of the audio content information,
wherein the radio is configured to receive the classified audio content information from the tuning engine, and to assign at least one audio content type to each tuning control input based on the classified audio content information, thereby allowing the radio user to access the at least one preferred type of audio content at the associated network address by activating a respective tuning control input.

2. The system of claim 1 further including a wireless transmission infrastructure, the radio being further configured to establish a wireless connection to the network via the wireless transmission infrastructure.

3. The system of claim 1 further including a network portal server connected to the network, the portal server being configured to provide the processing of the tuning engine.

4. The system of claim 3 further including at least one client computer connectable to the network, the client computer being configured to provide the user preference information to the tuning engine via the portal server.

5. The system of claim 3 wherein the radio is further configured to provide the user preference information to the tuning engine via the portal server.

6. The system of claim 1 wherein the tuning engine is further operative to store user identifier information for the at least one radio user, and to employ the user identifier information for associating the radio user with a respective set of user preference information.

7. The system of claim 1 wherein the tuning engine is further operative to locate and download at least one document associated with the respective audio content type, and to extract at least one attribute identifying characteristics of the audio content from the document.

8. The system of claim 1 wherein the tuning engine is further operative to authenticate a source of the user preference information.

9. The system of claim 1 further including at least one audio broadcast server connected to the network, the radio being further configured to access the at least one preferred type of audio content at a respective network address associated with the audio broadcast server.

10. The system of claim 9 wherein the tuning engine is further operative to test whether the at least one preferred type of audio content is available for access at the audio broadcast server.

11. The system of claim 10 wherein the tuning engine is further operative to test whether the at least one preferred type of audio content is available for access at the audio broadcast server by executing an echo-request routine.

12. The system of claim 11 wherein the tuning engine is further operative to determine a level of popularity for the preferred type of audio content, the echo-request routine being executed by the tuning engine at a frequency based on the level of popularity.

13. The system of claim 11 wherein the echo-request routine is executed by the tuning engine at respective audio broadcast servers on a round-robin basis.

14. A method for accessing audio content over a global communications network, comprising the steps of:
generating information pertaining to preferences of at least one user of a radio, the user preference information including at least one preferred audio content type, the radio including a user interface having a plurality of tuning control inputs;
storing the user preference information in at least one database of a tuning engine for the radio;
receiving audio content information including at least one network address associated with a respective audio content type at the tuning engine;
classifying the audio content information based on at least one attribute of the audio content information;
receiving the classified audio content information at the radio;
assigning at least one audio content type to each tuning control input of the radio based on the classified audio content information; and
activating a respective tuning control input of the radio to access the at least one preferred type of audio content at the associated network address.

15. The method of claim 14 further including the step of establishing a wireless connection to the network by the radio.

16. The method of claim 14 further including the step of providing the user preference information to the tuning engine by a client computer connected to the network.

17. The method of claim 14 further including the steps of storing user identifier information for the at least one radio user in the at least one database of the tuning engine, and employing the user identifier information to associate the radio user with a respective set of user preference information by the tuning engine.

18. The method of claim 14 further including the steps of locating and downloading at least one document associated with the respective audio content type by the tuning engine, and extracting at least one attribute identifying characteristics of the audio content from the document by the tuning engine.

19. The method of claim 14 further including the step of authenticating a source of the user preference information by the tuning engine.

20. The method of claim 14 wherein the activating step further includes accessing the at least one preferred type of audio content from at least one audio broadcast server connected to the network by the radio.

21. The method of claim 20 further including the step of testing whether the at least one preferred type of audio content is available for access at the audio broadcast server by the tuning engine.

22. The method of claim 21 wherein the testing step includes executing an echo-request routine by the tuning engine.

23. The method of claim 22 further including the step of determining a level of popularity for the preferred type of audio content, the testing step further including executing the echo-request routine at a frequency based on the level of popularity.

24. The method of claim 22 wherein the testing step includes executing the echo-request routine at respective audio broadcast servers on a round-robin basis.
